(19) United States
(12) Patent Application Publication
(10) Pub. No.: US 2013/0185986 A1
(43) Pub. Date: Jul. 25, 2013

(54) Bird Decoy Apparatus

(71) Applicant: Talmon R. Stiffler, Hot Springs, AR (US)

(72) Inventor: Talmon R. Stiffler, Hot Springs, AR (US)

(21) Appl. No.: 13/355,716

(22) Filed: Jan. 23, 2012

(51) Int. Cl. A01M 31/06

(52) U.S. Cl. 43/3

(57) ABSTRACT

A bird decoy apparatus comprising a base, a spring-loaded pulley connected to said base, wherein said pulley comprises a pulley cable, at least one rod having a first end and a second end, wherein a bird decoy is attached to said first end of said rod; a pole connected to said pulley and to said second end of said rod; and a substantially circular track connected to said base, said track having varying heights, wherein said rod is in contact with said track. A method for attracting game birds is also disclosed comprising the step of pulling the pulley cable of the bird decoy apparatus, which causes the rod with a bird decoy attached to travel around the track.

### CROSS-REFERENCE TO RELATED APPLICATIONS

Not applicable

### STATEMENT REGARDING FEDERALLY SPONSORED RESEARCH OR DEVELOPMENT

Not applicable

### BACKGROUND OF THE INVENTION

1. Field of the Invention

The present invention relates generally to a bird decoy apparatus and, more particularly, to a duck and goose decoy.

2. Brief Description of the Related Art

Decoys have been used for many years to attract wild game, such as ducks and geese, for hunting purposes. The prior art decoy devices can be positioned either on land or in water. Some of the attached decoys of the prior art devices remain stationary during operation, while others are capable of movement. To allow movement of the attached decoys, some of the prior art decoy devices require motors and gears.

The prior art decoy devices, however, do not allow the operator of the decoy device to control both the lateral movement of the attached decoys above the water or land and the vertical movement of the attached decoys.

It therefore would be desirable to develop a bird decoy apparatus that allows the operator of the decoy apparatus to manually control both the lateral and vertical movements of the attached decoys.

### BRIEF SUMMARY OF THE INVENTION

The present invention is directed to a bird decoy apparatus comprising (a) a base; (b) a spring-loaded pulley connected to said base, wherein said pulley comprises a pulley cable; (c) at least one rod having a first end and a second end, wherein a bird decoy is attached to said first end of said rod; (d) a pole comprising a first end and a second end, said first end of said pole connected to said pulley and said second end of said pole connected to said second end of said rod; and (e) a substantially circular track connected to said base, said track having varying heights, wherein said rod is in contact with said track.

The present invention is also directed to a method for attracting game birds comprising the steps of: (a) placing the bird decoy apparatus disclosed above in a body of water or on a piece of land, wherein said bird decoy apparatus further comprises a second cable; (b) attaching said second cable to a stationary object; and (c) pulling said pulley cable wherein pulling said pulley cable is effective to rotate said rod around said track.

The present invention is also directed to a method for attracting game birds comprising the steps of: (a) placing the bird decoy apparatus disclosed above in a body of water, wherein said bird decoy apparatus further comprises a second cable; (b) attaching said pulley cable to a stationary object; and (c) pulling said second cable wherein pulling said second cable is effective to rotate said rod around said track and to move said bird decoy apparatus across the surface of said body of water.

These and other features, objects and advantages of the present invention will become better understood from a consideration of the following detailed description of the preferred embodiments and appended claims in conjunction with the drawings as described following:

### BRIEF DESCRIPTION OF THE DRAWINGS

FIG. 1 is an elevated perspective view of the bird decoy apparatus.

FIG. 2A is a cross-sectional view of the first embodiment of the bird decoy apparatus.

FIG. 2B is a cross-sectional view of the second embodiment of the bird decoy apparatus.

### DETAILED DESCRIPTION OF THE INVENTION

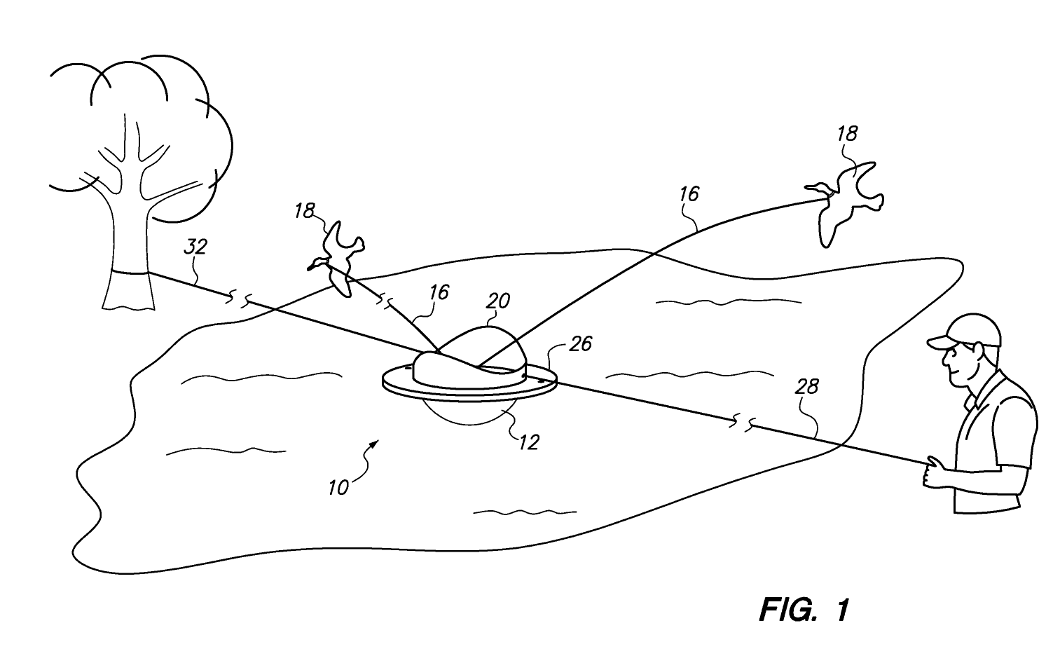

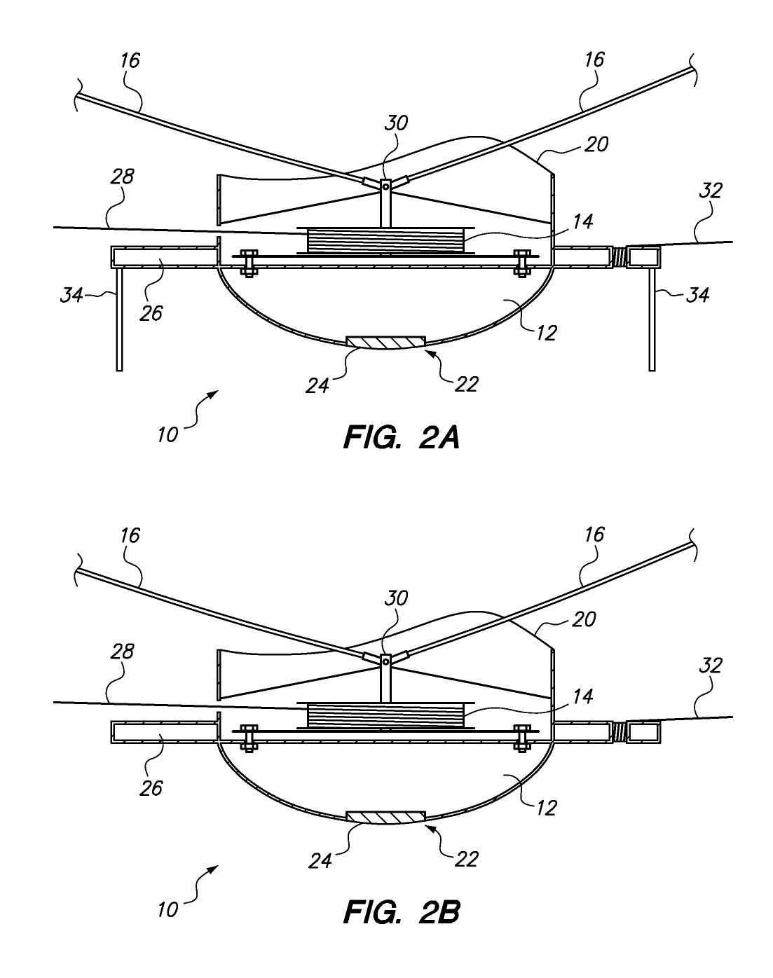

According to a preferred embodiment, the bird decoy apparatus 10 is comprised of a base 12, a spring-loaded pulley 14, one or more rods 16, one or more bird decoys 18, and a track 20, as shown in FIGS. 1, 2A, and 2B.

The base 12 is a container which is preferably a semi-spherical shape. The base 12 has a substantially flat top surface and an upwardly arched bottom surface. The base 12 has an opening 22 in its bottom surface for filling and draining a ballast material (e.g. water) from the base 12. A plug 24 is received by the opening 22 and prevents leakage of the ballast material contained in the base 12. The base 12 is capable of floating in a body of water, including, but not limited to, in a pond or lake.

Attached to the top surface of the base 12 is a platform 26. Platform 26 is preferably a circular-disc shape and made of plastic or a similar material that is light-weight and durable. The platform 26 is preferably filled with foam to maintain buoyancy in the event that the plastic comprising the platform 26 becomes damaged through use. The diameter of the platform 26 is preferably greater than the diameter of the base 12.

Resting on the top surface of the platform 26 is a spring-loaded pulley 14. The pulley 14 is connected to the base 12 and to the platform 26 by fasteners such as those well-known to those skilled in the art, including, but not limited to, bolts, rivets, and screws. The pulley 14 is also of the type well-known to those skilled in the art. The pulley 14 includes a reel with a spool of cable 28. The pulley cable 28 includes, but is not limited to, a string, line, or rope that is capable of being attached to the platform 26 and sufficiently strong to be pulled without breaking. The pulley 14 is positioned on the platform 26 such that the pulley cable 28 is horizontal to the platform 26 when it is extended from the pulley 14.

A pole 30 is attached to and extends vertically from the top of the pulley 14. The pole 30 preferably is cylindrical in shape and 0.75-1 inch in diameter. The length of the pole 30 is variable, but is preferably less than the length of the rods 16. Attached to the pole 30 are one or more rods 16. The rods 16 are attached to the pole 30 by means well-known to those skilled in the art, including, but not limited to, brackets or hinges. The rods 16 are preferably cylindrical in shape, made of aluminum, fiberglass, or graphite, and 10-30 feet in length. However, the shape, material, and length of the rods 16 may vary. The rods 16 are preferably attached to the pole 30 at less than a 90 degree angle. In one embodiment, the rods 16 are attached to the pole 30 via a hinge. The rods 16 are separated from one another by an equal distance. A bird decoy 18 is attached to the rod 16 at the opposite end of the rod 16 from its attachment to the pole 30. The decoy 18 is preferably a duck decoy, but instead may be any kind of game bird decoy. A second cable 32 is connected to the platform 26 and is of a similar type as the pulley cable 28.

An elevated track 20 is attached to the top surface of the platform 26. The track 20 is preferably made of plastic. In one embodiment, the base 12, the platform 26, and the track 20 are molded as one plastic piece. The track 20 is positioned in a substantially circular arrangement and surrounds the pulley 14. The diameter of the circle created inside the track 20 is less than the diameter of the platform 26. The height of the track 20 increases and decreases around the course of the track 20, preferably in the range of one inch to six inches in height. Thus, in one embodiment, the height of the track 20 gradually increases and decreases. However, in another embodiment, the height of the track 20 abruptly increases and decreases. The top surface of the track is preferably 0.5-1 inch in width. The rod 16 preferably contacts the top surface of the track 20 at a point approximately four to six inches from the point of attachment to the pole 30. The remainder of the rod 16 (from the point of contact with track 20 to the decoy 18 attached at the end of the rod 16) extends in the air over and away from the track 20 and the platform 26.

When the pulley cable 28 is pulled from the spool of the pulley 14, either manually by hand or by mechanical means, the pulley 14 rotates in a clockwise direction. This rotation of the pulley 14 causes a corresponding rotation of the pole 30 attached to the top of the pulley 14. As the pole 30 rotates, the rods 16 attached to the pole 30, and the decoys 18 attached to the rods 16, also rotate in a clockwise direction. Because of the contact between the rods 16 and the track 20, the rods 16 travel up-and-down along the track 20 as the pulley 14 rotates. Since the pulley is spring-loaded, when the pulley cable 28 is released back into the spool, the pulley 14, pole 30, rods 16, and decoys 18 rotate counter-clockwise. This movement of the rods 16 along the track 20 causes a circling movement of the decoys 18 in the air above the platform 26 in either a clockwise or counter-clockwise direction (depending on whether the pulley cable 28 is being pulled or released) and movement of the decoys 18 at varying elevations. Thus, by manipulating the pulley cable 28, the operator of the decoy apparatus 10 can simulate the circular flight patterns of game birds and control the movement of the decoys 18 vertically.

During this process, the second cable 32 is attached to a stationary object nearby, including, but not limited to, a tree, post, or stake. By tying the second cable 32 to a stationary object, the decoy apparatus 10 remains floating in essentially the same location in the water.

If, instead, the second cable 32 is pulled while the pulley cable 28 is tied to a nearby stationary object, then the operator can simultaneously control the movement of the decoys 18 both vertically and laterally. By pulling the second cable 32, the entire decoy apparatus 10 moves in the direction in which the second cable 32 is pulled. Therefore, the decoys 18 move laterally in the same direction as the rest of the decoy apparatus 10. Because the pulley cable 28 is tied, as the rest of the decoy apparatus 10 is pulled in the opposite direction, the pulley 14 is forced to rotate to release more pulley cable 28. This clockwise rotation of the pulley 14 causes a corresponding rotation of the pole 30 attached to the top of the pulley 14. As the pole 30 rotates, the rods 16 attached to the pole 30, and the decoys 18 attached to the rods 16, also rotate in a clockwise direction. Because of the contact between the rods 16 and the track 20, the rotation of the rods 16 causes the rods to travel up-and-down along the track 20 as the pulley 14 rotates. During this process, the decoys 18 both circle the platform 26 at varying heights as the rods move along the track 20, and move above the water in the direction in which the second cable 32 is being pulled. Thus, by manipulating the second cable 32, the operator of the decoy apparatus can simultaneously control the movement of the decoys 18 both vertically and laterally.

In an alternative embodiment, as shown in FIG. 2A, the decoy apparatus 10 is positioned on land instead of in water. In this embodiment, at least two stakes 34 are attached at opposite edges of the platform 26 at approximately 90 degree angles. In one embodiment, the stakes 34 are attached to the bottom of the platform 26. In another embodiment, the platform 26 has holes in its top surface which receives the stakes 34. The stakes have pointed tips and serve to anchor the decoy apparatus 10 in the ground. Stakes 34 may also be utilized in shallow water in which the decoy apparatus 10 would not be capable of floating. When the pulley cable 28 is pulled from the spool of the pulley 14, the pulley 14 rotates in a clockwise direction. This rotation of the pulley 14 causes a corresponding rotation of the pole 30 attached to the top of the pulley 14. As the pole 30 rotates, the rods 16 attached to the pole 30, and the decoys 18 attached to the rods 16, also rotate in a clockwise direction. Because of the contact between the rods 16 and the track 20, the rods 16 travel up-and-down along the track 20 as the pulley 14 rotates. Since the pulley is spring-loaded, when the pulley cable 28 is released back into the spool, the pulley 14, pole 30, rods 16, and decoys 18 rotate counter-clockwise. This movement of the rods 16 along the track 20 causes a circling movement of the decoys 18 in the air above the platform 26 in either a clockwise or counter-clockwise direction (depending on whether the pulley cable 28 is being pulled or released) and movement of the decoys 18 at varying elevations. Thus, by manipulating the pulley cable 28, the operator of the decoy apparatus 10 can simulate the circular flight patterns of game birds and control the movement of the decoys 18 vertically.

In another embodiment, instead of stakes 34 being attached to the platform 26, at least two rope loops (not shown) are attached to the top surface of the platform 26. The rope loops are capable of being extended from the platform 26 and staked in the ground, thereby anchoring the decoy apparatus 10 in the ground. Two cable holders (not shown) may also be attached to the top surface of the platform 26. The pulley cable 28 and the second cable 32 may be wrapped around the cable holders for storage when the decoy apparatus is not in use.

In yet another embodiment, a set of wheels (not shown) is attached to the bottom surface of the base 12. With wheels, the decoy apparatus 10 is capable of moving laterally across the ground. In this embodiment, the operator of the decoy apparatus 10 is capable of simultaneously controlling the movement of the decoys 18 vertically and laterally by manipulating the second cable 32 as explained above.

The decoy apparatus 10 preferably is 25-50 pounds in weight and is capable of being transported in a backpack.

The present invention has been described with reference to certain preferred and alternative embodiments that are intended to be exemplary only and not limiting to the full scope of the present invention as set forth in the appended claims. The present invention has also been described with reference to certain dimensions and materials which also are intended to be exemplary only.

We claim:

1. A bird decoy apparatus comprising:
(a) a base;
(b) a spring-loaded pulley connected to said base, wherein said pulley comprises a pulley cable;
(c) at least one rod having a first end and a second end, wherein a bird decoy is connected to said first end of said rod;
(d) a pole, wherein said pole is connected to said pulley and to said second end of said rod; and
(e) a substantially circular track connected to said base, said track having varying heights, wherein said rod is in contact with said track.

2. The bird decoy apparatus of claim 1 wherein said base is capable of floating in water.

3. The bird decoy apparatus of claim 1 wherein said base comprises a container capable of being filled with a ballast material.

4. The bird decoy apparatus of claim 3 wherein said container of said base comprises a plug.

5. The bird decoy apparatus of claim 1 further comprising a platform, wherein said platform has a top surface and bottom surface, said pulley connected to said top surface of said platform and said base connected to said bottom surface of said platform.

6. The bird decoy apparatus of claim 1 wherein said track is elevated.

7. The bird decoy apparatus of claim 1 wherein the height of said track increases and decreases.

8. The bird decoy apparatus of claim 1, wherein said rods are capable of traveling along said track.

9. The bird decoy apparatus of claim 5 further comprising at least two stakes.

10. The bird decoy apparatus of claim 3 wherein said ballast material is water.

11. The bird decoy apparatus of claim 7 wherein said height of said track gradually increases and decreases.

12. The bird decoy apparatus of claim 7 wherein said height of said track abruptly increases and decreases.

13. The bird decoy apparatus of claim 9 wherein said at least two stakes are connected to said bottom surface of said platform.

14. The bird decoy apparatus of claim 9 wherein said platform comprises at least two holes wherein said holes are capable of receiving said at least two stakes.

15. The bird decoy apparatus of claim 1 further comprising wheels, wherein said wheels are connected to the bottom surface of said base.

16. A method for attracting game birds comprising the steps of:
(a) placing a bird decoy apparatus of claim 1 in a body of water or on a piece of land, wherein said bird decoy apparatus further comprises a second cable;
(b) attaching said second cable to a stationary object; and
(c) pulling said pulley cable wherein pulling said pulley cable is effective to rotate said rod around said track.

17. A method for attracting game birds comprising the steps of:
(a) placing a bird decoy apparatus of claim 1 in a body of water, wherein said bird decoy apparatus further comprises a second cable;
(b) attaching said pulley cable to a stationary object; and
(c) pulling said second cable wherein pulling said second cable is effective to rotate said rod around said track and to move said bird decoy apparatus across the surface of said body of water.
